(19) United States
(12) Patent Application Publication
(10) Pub. No.: US 2023/0097152 A1
(43) Pub. Date: Mar. 30, 2023

(54) Pairwise Positive Document Frequency Weight Scheme and its Application

(71) Applicant: Arthur Zhang, Cambridge, MA (US)

(72) Inventor: Arthur Zhang, Cambridge, MA (US)

(21) Appl. No.: 17/489,562

(22) Filed: Sep. 29, 2021

(51) Int. Cl. G06N 20/00; G06F 16/93

(52) U.S. Cl. CPC G06N 20/00; G06F 16/93

(57) ABSTRACT

The present invention defines a few novel document weighting schemes and provides computation methods and computer program systems based on these. These schemes can quantify the features' capability of measuring the similarity of documents as well as the features' capability of distinguishing documents. A few variants and different combinations of the weighting schemes are also provided. An embodiment of the invention also includes the extension from common discrete token features to slightly complex features such as sentences. The invention also provides detailed illustration applications to the classical Euclidean document distance computation and the modern optimal transportation based document distance computation.

### FIELD OF THE INVENTION

This patent application refers to the earlier Provisional Application 63/198,209.

This patent considers the document frequency weighting scheme methods in classical information retrieval systems.

It relates to the prior art of Inverse Document Frequency (IDF).

The patent proposes some novel document weighting methods in information retrieval, which are universally applicable to all modern machine learning method frameworks for common tasks such as classification, prediction, webpage ranking and recommendation tasks etc.

Particularly we illustrate the application to two scenarios, namely the classical Euclidean distance computation and the popular Optimal Transportation (OT) based document distance computation in natural language processing.

### BACKGROUND OF THE INVENTION

It is a general belief that different features play different roles in the information retrieval and machine learning tasks. In other words, some features have relatively more import while some features are relatively less important for the considered tasks. In the past few decades researchers have developed various feature weighting methods which assign each feature a weight quantifying its importance.

One important observation made by Karen Sparck Jones in 1972 is that if a word appears in more documents in a corpus collection, then the word becomes less effective at distinguishing the documents. That means that a rare word is more effective at distinguishing the documents than frequent words. Let's use N denote the total number of documents in the corpus collection and D denote the number of documents containing the word. Then

$$\frac{N}{D}$$

is the reciprocal of the standard document frequency. To avoid the extreme situation of vanishing D=0, a simple smoothing is given by

$$\frac{c + N}{c + D} ,$$

where c is a non-negative real number. By taking c=1, this leads to the classical state-of-art Inverse Document Frequency formula:

$$IDF = log ( \frac{1 + N}{1 + D} ) .$$

For a given document, one can compute the term frequency(TF),denoted as f , of a word appearing in the document, that is, the counts of the word in the document divided by the total number of tokens of the document. Then the famous Term Frequency-Inverse Document Frequency (TF-IDF) is just given as the multiplication of f with IDF.

The above IDF approach comes from the feature's capability of distinguishing documents. Inversely, one can also design one from the point view of quantifying the features' capability of measuring similarity among documents. This is inspired from the simple fact that more sharing words appearing in two documents indicates that the two documents are more similar.

This and the next several following paragraphs introduce the basics of the optimal transportation based document distance computation and the downstream document classification using such computed document distance. The optimal transportation (OT) is an applied mathematical branch which studies the optimal transportation cost of moving mass from one space to another. In the past several years it has attracted a lot of interest in the machine learning community. In 2015 Kusner and his collaborators introduced the OT technique to measure the distance between documents in natural language processing.

The framework assumes that for two given documents of texts, X and Y, each is regarded as a sequence of word tokens. Ignoring the word orders, we can represent each document as a bag of words V=[w₁, w₂, . . . , wₙ]. Here n is the size of all the vocabulary in the documents. Each document can be first represented as a vector of frequency counts, and then normalized by their total sum of the frequency counts. This finally gives X=[x₁, x₂, . . . , xₙ] and Y=[y₁, y₂, . . . , yₙ], where the two vectors has unit mass. That is, the documents can be regarded as two discrete probability distributions, where the machinery from optimal transportation comes into play.

Now one can transport the total mass from X to Y, either the whole or some portion of a point xᵢ. This framework was first formulated by Kontsevich in 1942, namely balanced transportation. The total transportation cost is naturally defined as the distance weighted summation of moving all the mass from one space to another. Now one can ask what is the optimal transportation plan.

$$OT ( X , Y ) = {min}_{P} {\sum }_{i , j} {P}_{ij} Dist ( {x}_{i} , {y}_{j} ) \qquad ( 1 )$$

where P is all the possible transportation path which satisfy the following constraints: Σⱼ₌₁ⁿ Pᵢⱼ=xᵢ and Σᵢ₌₁ⁿ Pᵢⱼ=yⱼ. The Dist(xᵢ, yⱼ) is the distance between the word vectors of xᵢ and yⱼ, which are usually pretrained using popular algorithms such as Word2vec and publicly free .

Similarly, at the sentence level, i.e, we can regard each sentence as an individual feature rather than the common words. We can count the sentence frequencies in each document and form the normalized sentence vector representation for each document. That is, X=[sx₁, sx₂, . . . , sxₘ] and Y=[sy₁, sy₂, . . . , syₘ]. Here m is the total number of different sentences in the two documents. And we can have the similar OT formulation below:

$$OT ( X , Y ) = {min}_{P} {\sum }_{i , j} {P}_{ij} Dist ( {sx}_{i} , {sy}_{j} ) \qquad ( 2 )$$

where P is all the possible transportation path which satisfy the following constraints: Σⱼ₌₁ⁿ Pᵢⱼ=sxᵢ and Σᵢ₌₁ⁿ Pᵢⱼ=syⱼ. The sentence vectors sxᵢ and syⱼ are the weighted word vectors of all the words in the sentence, where the weight type for each word is identical to the selected feature document frequency type. The Dist(sx₁, syⱼ) is the vector distance between sentence vectors sxᵢ and syⱼ.

This paragraph reviews the classical Euclidean distance computation for a pair of documents. Following the notations above, X=[xᵢ, x₂, . . . , xₙ] and Y=[y₁, y₂, . . . , yₙ], where xᵢ and yⱼ are the word token frequencies for wᵢ and wⱼ. The classical Euclidean distance between documents X and Y, denoted as Dist_{XY}, is then given as

$${Dist}_{XY} = \sqrt{{\sum }_{k = 1}^{n} {( {x}_{k} - {y}_{k} )}^{2}} \qquad ( 3 )$$

### SUMMARY AND OBJECTS OF THE INVENTION

Here we first propose a similarity motivated pairwise document frequency, namely Positive Document Frequency (PDF), and its variants. This PDF assigns a metric to each pair of documents which accounts for the feature's importance contribution on the two documents' similarity.

Next we propose an integrated weighting scheme, namely Positive and Inverse Document Frequency (PIDF), by combining the PDF and IDF together. The PIDF thus has dual capability of assessing similarity with PDF and distinguishing with IDF.

The proposed schemes PDF, PIDF and their variants can easily be applied as weighting methods to any pairwise documents based metrics for downstream information retrieval and machine learning tasks.

Particularly for the optimal transportation based document distance computation, we apply the IDF, PDF, PIDF or their variant weightings to the word token feature frequencies for each pair of documents. Similarly, we can apply the sentence weighting SIDF, SPDF, SPIDF or their variant weightings to the sentence feature frequencies for each pair of documents.

### BRIEF DESCRIPTION OF DRAWINGS

FIG. 1 gives a brief summary of PIDF weighting procedure; and

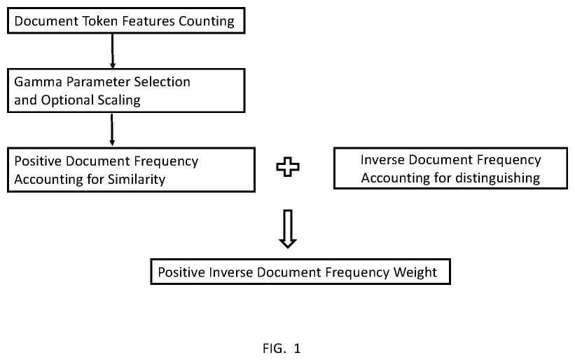

FIG. 2 gives a brief summary of the procedure of computing pairwise documents distance using the PIDF weighting scheme.

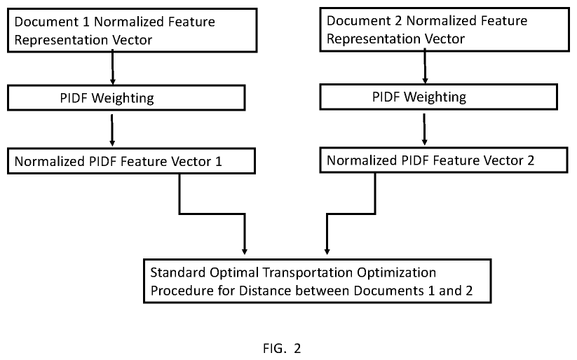

### DETAILED DESCRIPTION OF THE INVENTIONS

First for a given feature w, we will define a quantity Positive Document Frequency (PDF) for each pair of documents, which summarizes the feature w's contribution to the similarity of the two documents.

Note for two documents, total documents equals n=2 and the counts of the w feature d ∈ {0, 1, 2}. One can define PDF in a general form as

$$PDF ( w ) = \{ \begin{matrix}{γ}_{2} & if d = 2 \\ {γ}_{1} & if d = 1 \\ {γ}_{0} & if d = 0\end{matrix} \qquad ( 4 )$$

where γ₀, γy₁, and γ₂ are real numbers. There are numerous ways to define these numbers in terms of d and n.

For the typical downstream task of computing TF-IDF, the term frequency for a feature w with counts d=0 always gives zero. So it does not hurt to modify the definition (5) above to be the following.

$$PDF ( w ) = \{ \begin{matrix}{γ}_{2} & if d = 2 \\ {γ}_{1} & if d = 1 \\ 0 & if d = 0\end{matrix} \qquad ( 5 )$$

Alternatively, by taking the ratio of the γ₁ and γ₂ and we can further simplify the formula as following:

$$PDF ( w ) = \{ \begin{matrix}1 + γ & if d = 2 \\ 1 & if d = 1 \\ 0 & if d = 0\end{matrix} \qquad ( 6 )$$

where γ>0 is a non-negative real number, which indicates the extra effect when the feature appears in both documents. For example,

$$γ = log \frac{c + 2}{c + 1} with c = 1.$$

Optionally we can scale the PDF by multiplying a scaling factor. Let N denote the total of documents in the corpus collection and N be the frequency count, i.e, the number of documents containing the feature w. The scaling factor could be any function S=f(D, N) for some suitable function f. For example, let

$$\frac{c + D}{c + N}$$

be the simple smoothing of the document frequency for the feature w, where c ∈ [symbol] . And let f be the identify function. Then

$$S = \frac{D}{N}$$

if let c=0, which is the document frequency for w. If let f=log and c=1, then

$$S = log \frac{1 + D}{1 + N} .$$

The scaled PDF is given as:

scalePDF(w)=PDF(w)*S. (7)

To leverage the capability of measuring similarity and distinguishing of documents, we define the integrated Positive and Inverse Document Frequency (PIDF) as the simple sum of PDF and IDF.

PIDF(w)=PDF(w)+IDF(w). (8)

where the PDF and IDF represent the standard definition or their variants.

We generalize the PDF, IDF, PIDF and their variants to sentences or short documents. We denote the weighting scheme as Sentence Positive Document Frequency (SPDF). Let s=w₁w₂ . . . wₖ, where wᵢ's are nonstop words, then

$$SPDF ( s ) = {\sum }_{i = 1}^{k} PDF ( {w}_{i} ) \qquad ( 9 )$$

where the PDF can be the native PDF or any of its variants defined above.

Similarly, we extend the definition for IDF or its variants, and denoted the sentence level IDF as SIDF.

$$SIDF ( s ) = {\sum }_{i = 1}^{k} IDF ( {w}_{i} ) \qquad ( 10 )$$

The generalized SPIDF is defined to be the sum of SPDF and SIDF.

SPIDF(s)=SPDF(s)+SIDF(s) (11)

The above generic weighting schemes or their variants can be straightforwardly applied to any pairwise document distance computing scenarios. See the attached manuscript for a detailed demonstration in the scenario of optimal transportation for text documents. The corpus collection of documents here is very generic. For example, a document could be a webpage, a news article, a facebook message etc. A feature could be a word, a generic token or symbol, or something slightly complex such as a sentence etc.

As an illustration, we show how the weighting schemes can be applied to the classical Euclidean distance computation and the optimal transportation based document distance computation and classification. We use the same notation as in the background section above. At the word token level, the normalized word frequency vectors X=[x₁, x₂, . . . , xₙ] and Y=[y₁, y₂, . . . , yₙ] represent document X and document Y. At the sentence level we get the similar representations X=[sx₁, sx₂, . . . , sxₘ] and Y=[sy₁, sy₂, . . . , syₘ].

For the classical Euclidean distance computation for a pair of documents, we use PDF_{XY}(w) denote the pairwise PDF of word token w for document X and document Y. Multiplying each frequency with the corresponding PDF or its variant gives Xᵢ=xᵢPDF_{XY}(wᵢ) and Yⱼ=yⱼPDF_{XY}(wⱼ).

The classical Euclidean distance between documents X and Y, denoted as Dist_{xy}, is then given as

$$\begin{matrix}PDF - {Dist}_{XY} = \sqrt{{\sum }_{k = 1}^{n} {( {X}_{k} - {Y}_{k} )}^{2}} \\ = \sqrt{{\sum }_{k = 1}^{n} {PDF}_{XY}^{2} ( {w}_{k} ) {( {x}_{k} - {y}_{k} )}^{2}}\end{matrix} \qquad ( 12 )$$

Similarly, we can use IDF or PIDF to weight the word frequencies and get the following.

$$\begin{matrix}PIDF - {Dist}_{XY} = \sqrt{{\sum }_{k = 1}^{n} {( {X}_{k} - {Y}_{k} )}^{2}} \\ = \sqrt{{\sum }_{k = 1}^{n} {PIDF}_{XY}^{2} ( {w}_{k} ) {( {x}_{k} - {y}_{k} )}^{2}}\end{matrix} \qquad ( 13 )$$

For the optimal transportation, similarly we apply the weighting to the normalized word frequency vectors X=[x₁, x₂, . . . , xₙ] and Y=[y₁, y₂, . . . , yₙ]. Then we need to normalize the vectors one more time and finally compute the corresponding OT distances (1) using standard linear program solver or numeral approximation. For example, using PDF or its variant weighting schemes gives Xᵢ=xᵢPDF_{XY}(wᵢ) and Yⱼ=yⱼPDF_{XY}(wⱼ). Here we need to re-normalize Xᵢ and Yⱼ, and make the vectors X and Y to have their coordinates sum equal to unity. Similarly, using PIDF or its variant weighting gives Xᵢ=xᵢPIDF_{XY}(wᵢ) and Y=yⱼPIDF_{XY}(wⱼ), and do the same re-normalization.

At the sentence level, using SPDF or its variant weighting gives Xᵢ=xᵢSPDF_{XY}(wᵢ) and Yⱼ=yⱼSPDF_{XY}(wⱼ). Similarly, using SPIDF or its variant weighting gives Xᵢ=xᵢSPIDF_{XY}(wᵢ) and Yⱼ=yⱼSPIDF_{XY}(wⱼ). We will also need do a re-normalization first. The rest can be computed in the standard OT framework as above.

While the various embodiment of the present invention have been described above, it should be understood that they have been presented by way of example, and not limitation. As it is easy for a skilled person to make various changes in form and detail therein without departing from the spirit and scope of the invention. It is also to be understood that the following claims are intended to cover all of the generic and specific features of the invention herein described and all statements of the scope of the invention which, as a matter of language, might be said to fall there between.

What is claimed:

1. A document frequency weighting method PDF for a corpus of documents, comprising: choosing the intended feature set of documents;
performing a feature token or symbol counting for each pair of documents, with count value ends up in 0,1 or 2;
performing a parameter γ selection if not using the default value;
assigning a weighting value using the formula with selected parameter.

2. The method of claim 1, further comprising:
choosing an optional scale factor or the default 1;
computing the feature counts across the corpus for each feature and the total number of documents;
selecting the scale formula and compute the scale value with the counts data;
updating the weight value by multiplying the present weight with the scale for each feature of each pair of documents.

3. The method of claim 1, further comprising:
summing with the well-known Inverse Document Frequency to obtain the integrated PIDF document frequency.

4. The method of claim 1, wherein the feature is a slightly complex structure such as a sentence rather than the simple discrete token or symbol, further comprising:
computing the token weights first and sum them up as the assigned weight for the complex sentence feature.

5. The method of claim 1, wherein the feature is slightly complex structures such as sentences, further comprising:
computing the sentence SIDF by summing the individual token IDF in the sentence;
summing the sentence SPDF with SIDF to obtain the integrated SPIDF weight.

6. A document distance computing system comprising:
a server, including a processor and a memory, to:
accepts inputs as a collection of document;
selects a type of feature which can be a discrete token or a slightly complex one such as a sentence;
computes the feature frequency counts for each document and normalize the count vector to a unit vector;
selects a type of document frequency weighting and then computes the feature weight for each pair of documents;
multiplies the document representing vectors with the weightings and then renormalize them to be unit vectors;
outputs a document distance for each pair of documents in the corresponding framework, where it could be classical Euclidean document distance or the optimal transportation based word or sentence moving distance.

7. The system of claim 6, wherein the server' outputs may be followed by applying a standard procedure such as K Nearest Neighborhood (KNN), Support Vector Machine (SVM), Boosting Decision Trees or some Neural Network models etc for classification or prediction tasks etc.

8. The system of claim 6, wherein the server selects the discrete token features or the slightly complex features such as sentences etc. For discrete token features, the document frequency types include the PDF, IDF and PIDF as well as their variants. For the sentence-like structure features, the server sums the corresponding individual Document Frequency weights of each token in the sentence-like features.

9. The system of claim 6, wherein the document distance uses the optimal transportation, the server uses the memory to store the word vectors for the vocabulary; and the server computes the pairwise word vector distance as the transportation cost of moving a word unit to another word unit in the word pair. The server then uses standard linear program solver for the optimal transportation plan estimation.

10. The system of claim 6, wherein the document distance uses the Euclidean distance, the server computes the document word frequency vectors, multiplies the selected document frequency weights, and then computes the vector distance.
